(19) United States
(12) Patent Application Publication
(10) Pub. No.: US 2014/0244475 A1
(43) Pub. Date: Aug. 28, 2014

(54) METHOD AND SYSTEM FOR CREATING AN ISSUANCE BASED SECURITIES INDEX

(71) Applicant: Kai-Joseph Kemnitz, London (GB)

(72) Inventor: Kai-Joseph Kemnitz, London (GB)

(21) Appl. No.: 14/272,521

(22) Filed: May 8, 2014

Related U.S. Application Data
(63) Continuation-in-part of application No. 13/557,489, filed on Jul. 25, 2012.

(51) Int. Cl. G06Q 40/04

(52) U.S. Cl. CPC G06Q 40/04
USPC 705/37

(57) ABSTRACT

A method and system to create an issuance based securities index for a period i is provided for constructing a transparent and cost-efficient securities index. The method and system to create an issuance based securities index considers historical issuance notional and historical issuance distance for each security to be used for index construction purposes so as to determine the expected allocation weight as well as index allocation for each respective security. The method and system to construct an issuance based securities index further only considers securities for inclusion within the issuance based securities index at their time of issuance. The method and system to create an issuance based securities index is performed via a number of steps by deriving issuance cycle, notional weight, expected allocation cycle, allocation weight and index allocation. These values are applied into a statistical formula to calculate the index value of the issuance based securities index.

### PRIORITY

This application is a continuation-in-part application of U.S. application Ser. No. 13/557,489 filed on Jul. 25, 2012, which is fully incorporated herein.

### BACKGROUND OF THE INVENTION

1. Field of Invention

The present invention generally relates to securities investing and more specifically to the creation of an issuance based securities index.

2. Description of Related Art

Generally, an index is defined by a predetermined universe of securities or selection criteria of securities. Indices have been created in order to facilitate and evaluate the business of both active and passive portfolio management. In the case of active investment & portfolio management, indices serve the purpose of evaluating the performance and returns of such an active investment strategy, whereas in the case of passive portfolio management an index is used as a benchmark to be tracked and followed.

Various methods have been developed for both active and passive investment management to best utilize indices and for the purpose of creating passive portfolios and benchmarks. Further, methods have been used to develop various indices by either equal weighing or market capitalization weighing its constituents. Often every security in the predetermined universe of securities is included in the index. Sometimes statistical modeling is used to create a portfolio that duplicates the profile, risk & performance characteristics and security weights of an index without actually owning every security included in the index.

Generally, securities indices are rebalanced to reflect the new securities entering the index as well as those leaving the index and many times require a user to constantly re-balance his security holdings to best replicate the index performance. Conventional securities indices are sometimes not re-balanced at the same time as securities are issued, re-opened or introduced; very often there is a lag in between the issuance date of the security and the index re-balancing date. Thus, the user is required to purchase and sell securities in the secondary market while incurring the transaction and bid/offer costs usually associated with such transactions. Therefore there is a need for a method and system to develop an issuance based securities index which includes the securities at the time of issuance, which relies on historical issuance notional to determine future index allocations, and which does not alter the amount of a security included in the issuance based securities index once such has been allocated.

### SUMMARY OF THE INVENTION

In accordance with the teachings of this invention, a method and system to create an issuance based securities index is provided.

An object of the present invention is to provide an issuance based securities index having taken into account the historical issuance notional and historical issuance distance of each security included in the issuance based securities index.

Another object of the present invention is to provide a method and system of creating an issuance based securities index including only securities at their time of issuance.

Another object of the present invention is to provide a method and system to create an issuance based securities index taking into account the issuance distance, notional weight, expected allocation cycle, allocation weight and index allocation of each security included in the issuance based securities index.

Another object of the present invention is to provide a method and system of creating an issuance based securities index taking into account unallocated cash and calculating the index value of the issuance based securities index.

### BRIEF DESCRIPTION OF DRAWINGS

FIG. 1 illustrates a flowchart to create an issuance based securities index, in accordance with a preferred embodiment of the present invention.

FIG. 2 illustrates a process flow to derive issuance cycle, in accordance with a preferred embodiment of the present invention.

FIG. 3 illustrates a process flow to derive notional weight, in accordance with a preferred embodiment of the present invention.

FIG. 4 illustrates a process flow to derive expected allocation cycle, in accordance with a preferred embodiment of the present invention.

FIG. 5 illustrates a process flow to derive allocation weight, in accordance with a preferred embodiment of the present invention.

FIG. 6 illustrates a process flow to derive index allocation, in accordance with a preferred embodiment of the present invention.

FIG. 7 illustrates a process flow to calculate index value, in accordance with a preferred embodiment of the present invention.

FIG. 8 illustrates a conceptual block diagram of an issuance based securities index system, in accordance with a preferred embodiment of the present invention.

FIG. 9 illustrates an embodiment of the index valuation calculation system.

### DETAILED DESCRIPTION OF THE INVENTION

The following discussion of the embodiments of the invention directed to a method and system for creating an issuance based securities index is merely exemplary in nature and is in no way intended to limit the scope of invention or its applications or uses. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

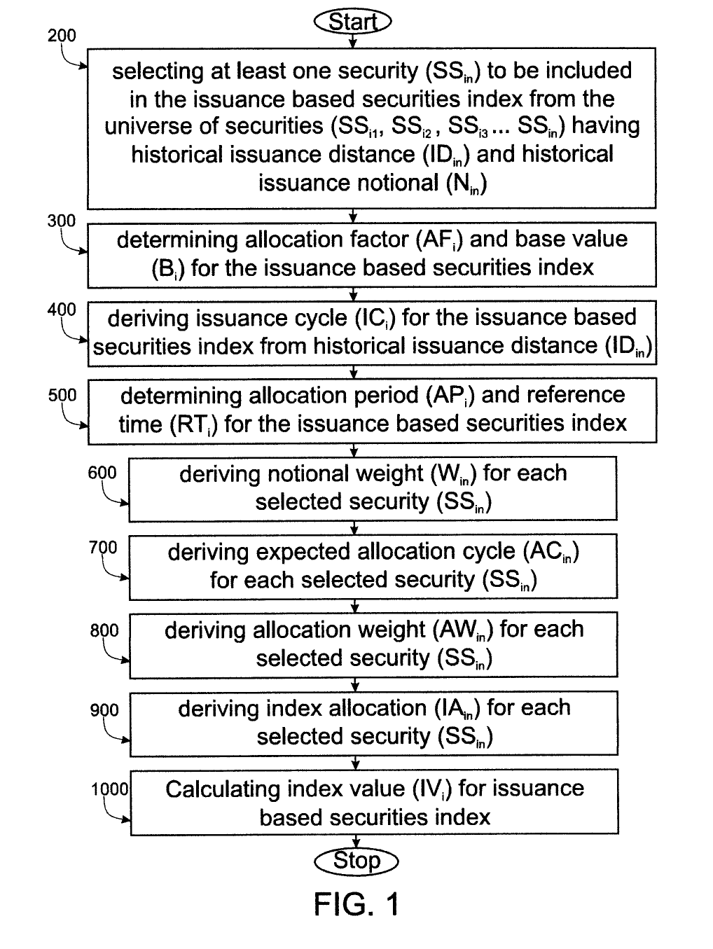

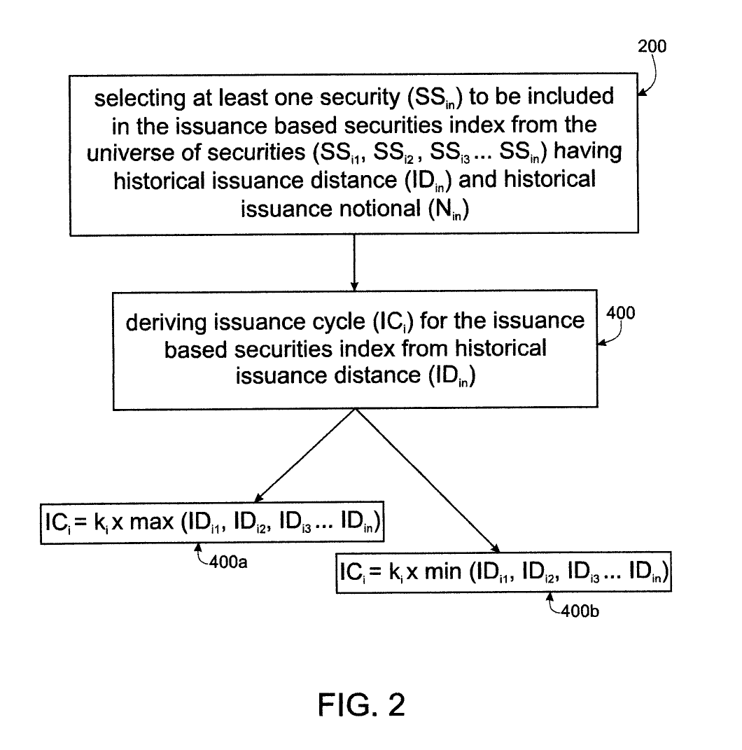

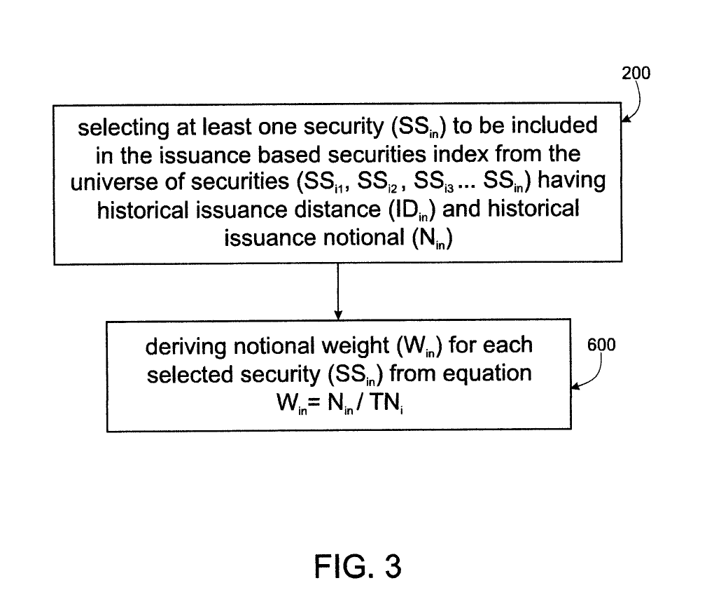

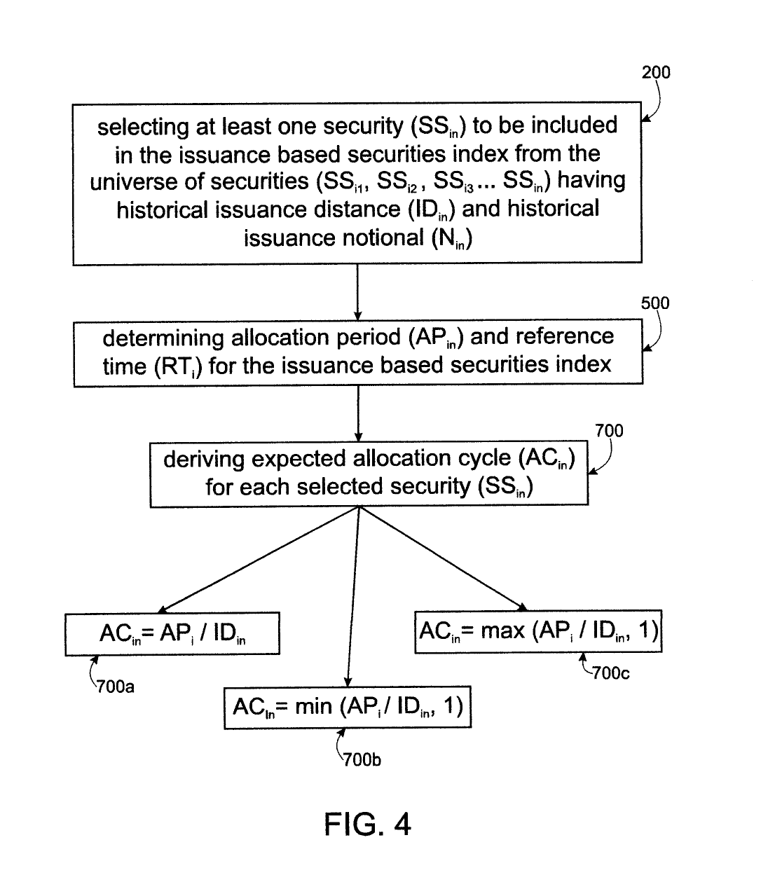

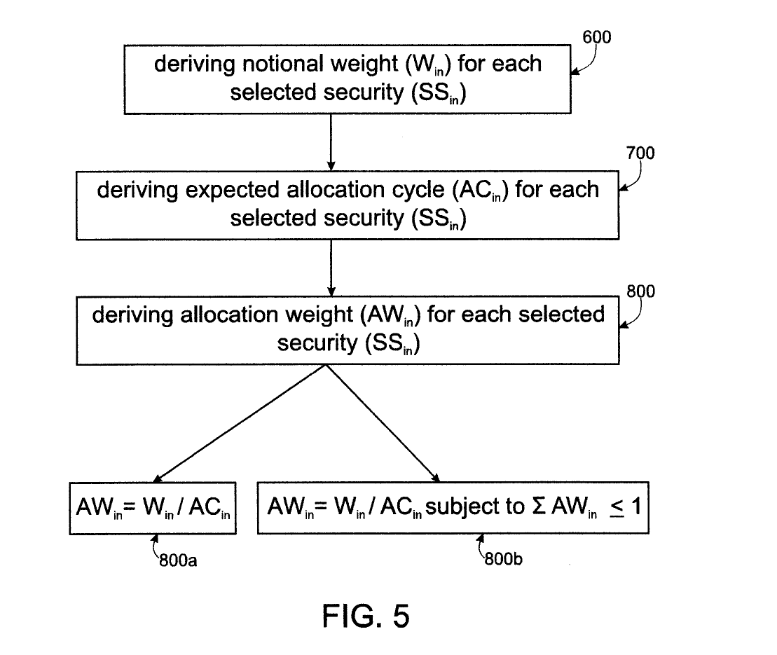

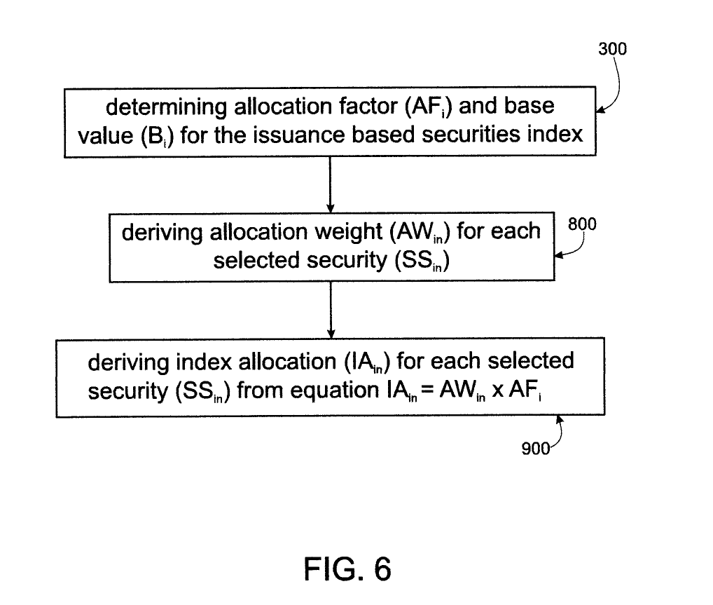

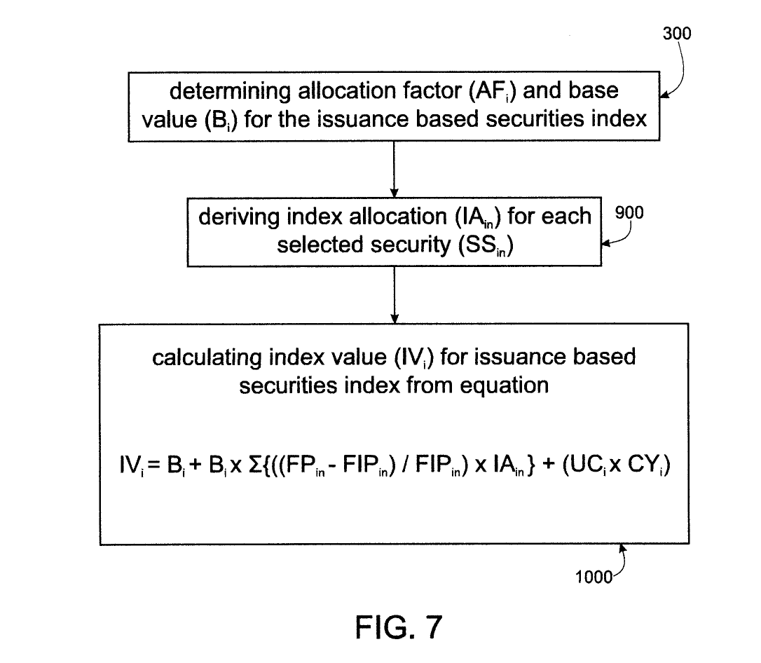

FIG. 1 illustrates a flowchart of a method 100 for creating an issuance based securities index for period i. The method 100 to create an issuance based securities index for a period i is explained by referring to FIG. 2, FIG. 3, FIG. 4, FIG. 5, FIG. 6, and FIG. 7 of the present invention, wherever necessary for ease of understanding. In accordance with a preferred embodiment of the present invention, the flowchart of a method 100 initiates with a step 200 to select at least one security (SSᵢₙ) from the universe of securities (SSᵢ₁, SSᵢ₂, SSᵢ₃ . . . SSᵢₙ) to be included in the issuance based securities index. In a preferred embodiment of the present invention the selected security (SSᵢₙ) may take on a form of a set of specific securities which may objectively be determined on the basis of characteristics as defined by a user. These characteristics will allow objective determination as to whether or not a security is to be included in the issuance based securities index. Examples of characteristics include but are not limited to asset class, industry sector, issuer, credit quality, credit rating, maturity date, issuance date, duration, coupon, dividend, payout, etc. The selected security (SSᵢₙ) may be defined as a range of securities, set of securities, selection criteria, or as a combination of multiple definitions of securities etc. Examples of the universe of securities (SSᵢ₁, SSᵢ₂, SSᵢ₃ . . . SSᵢₙ) include but are not limited to fixed income securities, equities, commodities, government bonds, agency bonds, mortgage bonds, corporate bonds, high yield bonds, international bonds, foreign currency bonds, covered bonds, convertible bonds, common stocks, domestic stocks, foreign shares, preferred shares, exchange traded funds, commodity linked notes, commodity based funds, structured products of any type, futures, funds of any type, private placements and non-listed securities etc.

In a preferred embodiment of the present invention, step 200 is performed by the user. The selected security (SSᵢₙ) includes a historical issuance distance (IDᵢₙ) and a historical issuance notional (Nᵢₙ). In a preferred embodiment of the present invention, the historical issuance distance (IDᵢₙ) is the most recent time span between successive issuance dates of the same or similar security prior to period i, and the historical issuance notional (Nᵢₙ) is defined as the notional of the same or similar security issued on each issuance occasion. The historical issuance distance (IDᵢₙ) may be measured in terms of time and may be determined in any measure of time. The historical issuance notional (Nᵢₙ) is measured in terms of currency amount and can be determined in any measure of currency of any country. In another embodiment of the present invention, the historical issuance distance (IDᵢₙ) or historical issuance notional (Nᵢₙ) is not available, or the user feels that the issuance based securities index is better served by not relying on historical data, then the historical issuance distance (IDᵢₙ) or historical issuance notional (Nᵢₙ) inputs may be determined by the user through either self-determination or by relying on external references such as, but not limited to, issuer statements, issuance projections, media articles or publications etc.

The step 200 is followed by a step 300 to determine an allocation factor (AFᵢ) and a base value (Bᵢ) for the issuance based securities index. The step 300 to select the allocation factor (AFᵢ) and the base value (Bᵢ) are performed by the user. The allocation factor (AFᵢ) and base value (Bᵢ) is explained in detail in conjunction with FIG. 6 and FIG. 7 respectively of the present invention. The step 300 is followed by a step 400 to derive the issuance cycle (ICᵢ) of the issuance based securities index. The step 400 to derive the issuance cycle (ICᵢ) is explained in detail in conjunction with FIG. 2 of the present invention. The step 400 is followed by a step 500 to determine the allocation period (APᵢ) and reference time (RTᵢ) for the issuance based securities index. The allocation period (APᵢ) and reference time (RTᵢ) is explained in detail in conjunction with FIG. 4 and FIG. 3 respectively of the present invention. The step 500 is followed by a step 600 to derive notional weight (Wᵢₙ) for each selected security (SSᵢₙ). The step 600 is explained in detail in conjunction with FIG. 3 of the present invention. The step 600 is followed by a step 700 to derive expected allocation cycle (ACᵢₙ) for each selected security (SSᵢₙ). The step 700 is explained in detail in conjunction with FIG. 4 of the present invention. The step 700 is followed by a step 800 to derive the allocation weight (AWᵢₙ) for each selected security (SSᵢₙ). The step 800 is explained in detail in conjunction with FIG. 5 of the present invention. The step 800 is followed by a step 900 to derive the index allocation (IAᵢₙ) for each selected security (SSᵢₙ). The step 900 is explained in detail in conjunction with FIG. 6 of the present invention. The step 900 is followed by a step 1000 to calculate the index value (IVᵢ) of the issuance based securities index for period i. The step 1000 is explained in detail in conjunction with FIG. 7 of the present invention.

FIG. 2 illustrates a process flow of step 400 to derive the issuance cycle (ICᵢ) for the issuance based securities index. In a preferred embodiment of the present invention, the step 400 is to derive the issuance cycle (ICᵢ) for the issuance based securities index from the historical issuance distance (IDᵢₙ) of each selected security (SSᵢₙ). In a preferred embodiment, the step 400 to derive issuance cycle (ICᵢ) is calculated either by equation 400a or equation 400b. The issuance cycle (ICᵢ) is measured in terms of time and may be determined in any measure of time. With reference to step 200, the historical issuance distance (IDᵢₙ) for each selected security (SSᵢₙ) is determined. An exemplary embodiment of determining the historical issuance distance (IDᵢₙ) is shown in Example A of the present invention. In an embodiment of the present invention step 400 is derived from the equation 400a ICᵢ=kᵢ×max (IDᵢ₁, IDᵢ₂, IDᵢ₃ . . . IDᵢₙ) wherein kᵢ is defined as the issuance cycle multiplier. The issuance cycle multiplier (kᵢ) is a positive number and is determined by the user. In another embodiment of the present invention step 400 is derived from the equation 400b ICᵢ=kᵢ×min (IDᵢ₁, IDᵢ₂, IDᵢ₃ . . . IDᵢₙ).

FIG. 3 illustrates a process flow of step 600 to derive the notional weight (Wᵢₙ) for each selected security (SSᵢₙ). The notional weight (Wᵢₙ) for each selected security (SSᵢₙ) is derived during the reference time (RTᵢ) from the historical issuance notional (Nᵢₙ) of each selected security (SSᵢₙ). With reference to step 200 from FIG. 1, the value of historical issuance notional (Nᵢₙ) for each selected security (SSᵢₙ) is determined. The reference time (RTᵢ) is the time period during which the notional weight (Wᵢₙ) for each selected security (SSᵢₙ) is determined and during which historical issuance notional (Nᵢₙ) is referenced. The reference time (RTᵢ) is determined in terms of a time range with a defined start date and end date. The reference time (RTᵢ) is measured in terms of time and may be determined in any measure of time. In an embodiment of the present invention the reference time (RTᵢ) is determined as being the time range from (Tᵢ−(pᵢ×ICᵢ)) until (Tᵢ) where pᵢ is a positive number defined by the user and is used for the purpose of increasing or decreasing the reference time (RTᵢ). Tᵢ is the date of index reference which is the date, as defined by the user, from which the reference time (RTᵢ) is determined. With reference to step 200 from FIG. 1, in a preferred embodiment of the present invention, the notional weight (Wᵢₙ) for each selected security (SSᵢₙ) is derived from equation notional weight (Wᵢₙ)=historical issuance notional (Nᵢₙ)/total historical issuance notional (TNᵢ). The values of historical issuance notional (Nᵢₙ) and total historical issuance notional (TNᵢ) for the purposes of deriving notional weight (Wᵢₙ) are determined during the reference time (RTᵢ). The total historical issuance notional (TNᵢ) is the sum of all historical issuance notional (Nᵢₙ) for each selected security (SSᵢₙ) during the reference time (RTᵢ) for period i. The notional weight (Wᵢₙ) represents the proportion of historical issuance notional (Nᵢₙ) for each selected security (SSᵢₙ) issued relative to the total historical issuance notional (TNᵢ) during the reference time (RTᵢ). The notional weight (Wᵢₙ) is a number. The notional weight (Wᵢₙ) of each selected security (SSᵢₙ) is used to derive the allocation weight (AWᵢₙ) (reference to FIG. 1, step 800) of each selected security (SSᵢₙ). The step 800 to derive allocation weight (AWᵢₙ) for each selected security (SSᵢₙ) is explained in detail in conjunction with FIG. 5 of the present invention.

FIG. 4 illustrates a process flow of step 700 to derive the expected allocation cycle (ACᵢₙ) for each selected security (SSᵢₙ). In a preferred embodiment of the present invention the step 700 is to derive the expected allocation cycle (ACᵢₙ) for each selected security (SSᵢₙ) during the allocation period (APᵢ) of the issuance based securities index. In a preferred embodiment of the present invention, the step 700 to derive the expected allocation cycle (ACᵢₙ) for each selected security (SSᵢₙ) is calculated from either equation 700a or 700b or 700c. The expected allocation cycle (ACᵢₙ) is the expected number of issuances of a selected security (SSᵢₙ) expected to occur during the allocation period (APᵢ given the historical issuance distance (IDᵢₙ) of each selected security (SSᵢₙ). The expected allocation cycle (ACᵢₙ) for each selected security (SSᵢₙ) is a number. The allocation period (APᵢ) is a time range during which the allocation of the issuance based securities index for period i is performed. Further, the allocation period (APᵢ) is used to determine the expected allocation cycle (ACᵢₙ) for each selected security (SSᵢₙ). The allocation period (APᵢ) is determined in terms of a time range with a defined start date and end date. The allocation period (APᵢ) is measured in terms of time and may be determined in any measure of time. In an embodiment of the present invention the allocation period (APᵢ) of step 500 is derived as being the time range from (TAᵢ) until (TAᵢ+(mᵢ×ICᵢ)) where mᵢ is a positive number defined by the user and is used for the purpose of increasing or decreasing the allocation period (APᵢ). TA is the date of index allocation which is the date as defined by the user from which the allocation period (APᵢ) is determined. With reference to step 200, the historical issuance distance (IDᵢₙ) for each selected security (SSᵢₙ) and with reference to step 500 the allocation period (APᵢ) for the issuance based securities index is determined. In an embodiment of the present invention the step 700 is derived from equation 700a ACᵢₙ=APᵢ/IDᵢₙ. In another embodiment of the present invention step 700 is derived from equation 700b ACᵢₙ=min (APᵢ/IDᵢₙ, 1). In another embodiment of the present invention step 700 is derived from equation 700c ACᵢₙ=max (APᵢ/IDᵢₙ, 1).

FIG. 5 illustrates a process flow of step 800 to derive the allocation weight (AWᵢ) for each selected security (SSᵢₙ). In a preferred embodiment of the present invention, the step 800 to derive the allocation weight (AWᵢₙ) for each selected security (SSᵢₙ), is initiated with the step 600 to derive the notional weight (Wᵢₙ) for each selected security (SSᵢₙ) and followed by the step 700 to derive the expected allocation cycle (ACᵢₙ) for each selected security (SSᵢₙ). In a preferred embodiment of the present invention, the step 800 to derive the allocation weight (AWᵢₙ) for each selected security (SSᵢₙ) is calculated from either equation 800a or 800b. The allocation weight (AWᵢₙ) for each selected security (SSᵢₙ) is the expected weight of each selected security (SSᵢₙ) relative to the total expected issuance of selected security (SSᵢₙ) during period i. The allocation weight (AWᵢₙ) is a number. With reference to step 600, the notional weight (Wᵢₙ) for each selected security (SSᵢₙ), and with reference to step 700 the expected allocation cycle (ACᵢₙ) for each selected security (SSᵢₙ) is derived. In an embodiment of the present invention the step 800 is derived from equation 800a AWᵢₙ=Wᵢₙ/ACᵢₙ. In another embodiment of the present invention the step 800 is derived from equation 800b AWᵢₙ=Wᵢₙ/ACᵢₙ subject to ΣAWᵢₙ≦1.

FIG. 6 illustrates a process flow of step 900 to derive the index allocation (IAᵢₙ) for each selected security (SSᵢₙ). In a preferred embodiment of the present invention, the step 900 is to derive the index allocation (IAᵢₙ) for each selected security (SSᵢₙ) from the allocation weight (AWᵢₙ) of each selected security (SSᵢₙ) and the allocation factor (AFᵢ) of the issuance based securities index. The index allocation (IAᵢₙ) is the expected allocation of each selected security (SSᵢₙ) to the issuance based securities index issued during period i. The index allocation (IAᵢₙ) is a number. With reference to step 300 the allocation factor (AFᵢ) for the issuance based securities index is determined, and with reference to step 800 the allocation weight (AWᵢₙ) for each selected security (SSᵢₙ) is derived. In an embodiment of the present invention step 900 is derived from equation IAᵢₙ=AWᵢₙ×AFᵢ. The allocation factor (AFᵢ) is the proportion of the issuance based securities index allocated during period i. The allocation factor (AFᵢ) may also be defined by the user through pre-defined rules such as, but not limited to, the cash residual available, the incoming funds to be allocated, or another strategy as defined by the user. Incoming funds may include but are not limited to new funding, maturing securities dividends, and interest payments. The allocation factor (AFᵢ) is a number. The allocation factor (AFᵢ) serves the purpose of allowing the user to spread the allocation of the issuance based securities index over multiple allocation periods (APᵢ).

FIG. 7 illustrates a process flow of step 1000 to calculate the index value (IVᵢ) of the issuance based securities index for period i. The process flow to reach step 1000 is calculated by taking reference of the step 300 to determine base value (Bᵢ) of the issuance based securities index and then followed by the step 900 to derive index allocation (IAᵢₙ) for each selected security (SSᵢₙ). In a preferred embodiment of the present invention step 1000 is calculated from equation IVᵢ=Bᵢ+Bᵢ×Σ{((FPᵢₙ−FIPᵢₙ)/FIPᵢₙ)×IAᵢₙ}+(UCᵢ×CYᵢ). Here, FIPᵢₙ denotes the full issuance price and FPᵢₙ denotes the full price for each selected security (SSᵢₙ). The UCᵢ denotes unallocated cash in the issuance based securities index. The CYᵢ denotes cash yield of the issuance based securities index and further represents the interest rate earned on unallocated cash (UCᵢ) during period i as defined by the user. The full issuance price (FIPᵢₙ) is the issuance price of each security in the universe of securities (SSᵢ₁, SSᵢ₂, SSᵢ₃ . . . SSᵢₙ) in addition to any accretion, dividend, or payment that has not been disbursed. The full issuance price (FIPᵢₙ) is determined at the time of issuance when the security is issued, re-opened, or introduced. The full issuance price (FIPᵢₙ) is measured in terms of currency amount and may be determined in any measure of currency of any country. The unallocated cash (UCᵢ) is defined as the unallocated cash in the issuance based securities index. The unallocated cash (UCᵢ) may arise due to a variety of factors such as, but not limited to the user's decision to not allocate the full issuance based securities index, the distribution of payments (such as interest payments, dividends, maturing notional, etc.), non-issuance of selected security (SSᵢₙ), or the issue price of selected security (SSᵢₙ). The unallocated cash (UCᵢ) may be a number or another security index as defined by the user. The full price (FPᵢₙ) is the market price of each selected security (SSᵢₙ) in addition to any accretion, dividend, or payment that has not been disbursed. The full price (FPᵢₙ) is measured in terms of currency amount and may be determined in any measure of currency of any country. The full price (FPᵢₙ) is determined at the time of index valuation (TIVᵢ). The time of index valuation (TIVᵢ) is the time at which the full price (FPᵢₙ) of each selected security (SSᵢₙ), and hence the index value (IVᵢ) of the issuance based securities index is determined for period i. With the reference to step 300 from FIG. 1, the base value (Bᵢ) of the issuance based securities index is determined. The base value (Bᵢ) of the issuance based securities index is a number selected by the user so as to scale the index value of the issuance based securities index to a desired reference value.

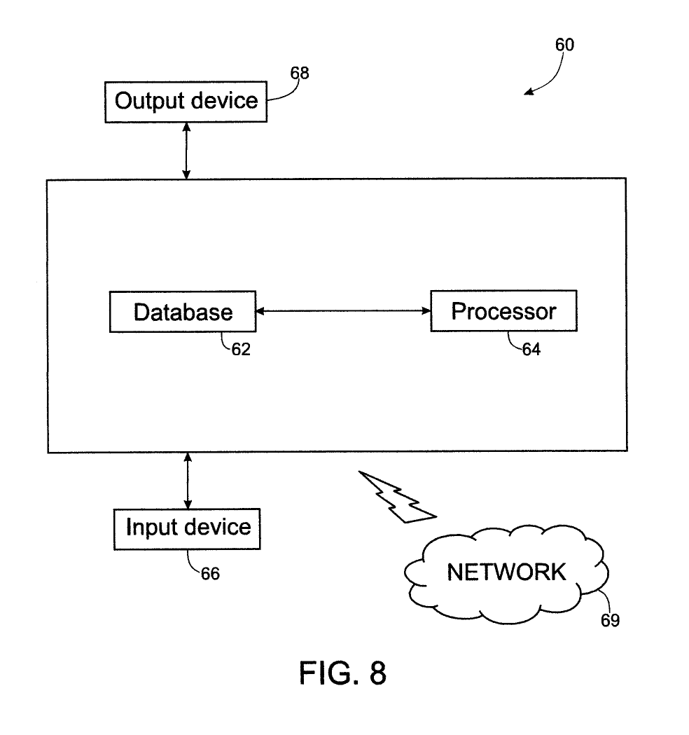

FIG. 8 illustrates a conceptual block diagram of an issuance based securities index system 60, in accordance with a preferred embodiment of the present invention. The issuance based securities index system 60 includes a database 62 and a processor 64 connected to the database 62. The database 62 stores and permits retrieval of data about the universe of securities (SSᵢ₁, SSᵢ₂, SSᵢ₃ . . . SSᵢₙ). Examples of database 62 include but are not limited to hard disk, compact disc, pen drive, flash memory stick, or other hardware databases. The processor 64 is configured to perform steps as described in the method 100 (referring to FIG. 1) through a software based program. Examples of processor 64 include but are not limited to CPU, integrated circuit or other hardware processors. In another embodiment of the present invention the issuance based securities index system 60 includes an input device 66 and an output device 68. The input device 66 is connected to the processor 64 to input various parameters. Examples of input device 66 include but are not limited to a keyboard, a mouse, or any other similar device. The output device 68 is connected to the processor to display the steps performed by the processor 64. Examples of output device include but are not limited to liquid crystal display (LCD), plasma, cathode ray tube (CRT) monitor, or other hardware output devices. In another embodiment of the present invention, the system 60 is connected to a network 69. The system 60 may be performed in a network.

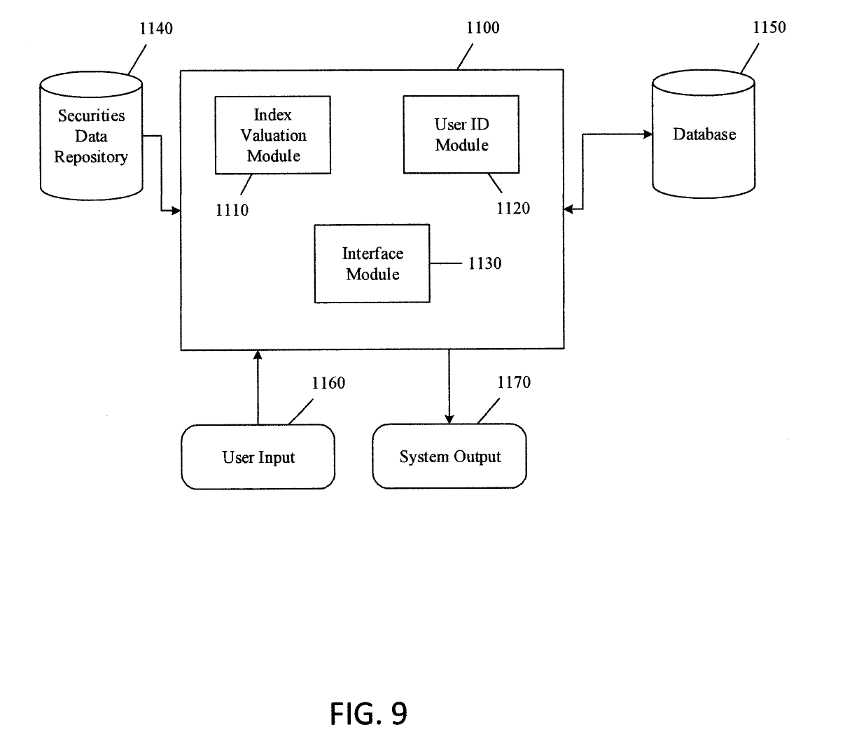

FIG. 9 illustrates the usage of the index valuation calculation system 1100. The index valuation calculation system 1100 is a computer processing device accessible through a user interface device. The index valuation calculation system 1100 may be accessible locally or it may be a server computer accessible through an internet interface connection. The index valuation calculation system 1100 utilizes a microprocessor and local memory unit to perform the calculations and processes stated herein. The index valuation calculation system 1100 is comprised of a plurality of software modules. In the embodiment of the index valuation calculation system 1100 displayed, the index valuation calculation system 1100 comprises an index valuation module 1110, a user ID module 1120, and an interface module 1130. The index valuation calculation system 1100 is configured to be in communication with a securities data repository 1140 and a database 1150. The index valuation calculation system 1100 can receive input information 1160 from a user and can generate output information 1170.

The securities data repository 1140 may be any suitable type or combination of computer-readable storage media including, for example, volatile or non-volatile memory, magnetic storage, optical storage, random access memory, read only memory, semiconductor memory, and so forth. In some embodiments, information from the securities data repository 1140 may be combined in a single storage medium or distributed across multiple storage media. Information stored in the securities data repository 1140 may be any information relevant to the system, including but not limited to, specific securities available in the securities universe, issuance dates, maturity dates, historical issuance notionals, full issuance prices, full prices, and any other relevant information utilized by the index valuation module 1110.

The database 1150 may be any suitable type or combination of computer-readable storage media including, for example, volatile or non-volatile memory, magnetic storage, optical storage, random access memory, read only memory, semiconductor memory, and so forth. In some embodiments, information from the database 1150 may be combined in a single storage medium or distributed across multiple storage media. The database 1150 may store any information relevant or utilized by the system, including but not limited to, output information, user ID preferences, or specific indices. The interface module 1130 generates a graphical user interface through which a user may utilize the index valuation module 1110.

The user ID module 1120 allows a user to create a unique password protected user ID. Information about the user, including contact information, is stored in the database 1150 in connection with the user's user ID. The user may save other information in the database 1150 in connection with the user's user ID. The other information may include user preferences, preferred information for use by the index valuation module 1110, specific indices, output preferences, or any other relevant data or information used by the system or created through the system.

The index valuation module 1110 creates the issuance based securities index. The index valuation module 1110 pulls relevant information from the securities data repository 1140. Alternatively, the index valuation module 1110 may utilize information from the user input 1160 if directed to do so by a user. The index valuation module 1110 may programmatically determine the historical issuance distance, the historical issuance notional, the allocation period, or the reference time for any security based on information obtained from the securities data repository 1140 or information from the user input 1160. The index valuation module 1110 may programmatically derive the issuance cycle, the notional weight, the expected allocation cycle, the allocation factor, the base value, the allocation weight, the index allocation, and the index value for any index of selected securities based on information obtained from the securities data repository 1140 or information from the user input 1160. The index valuation module 1110 generates an output of information 1170. The system output 1170 may be in any format. The system output 1170 may be any information relevant to the index valuation calculation system 1100. The system output 1170 may output information to computer storage, to a graphical user interface, to the database 1150, to a report, to a message, or to any other device or means to permit a user to receive the output information. The system output 1170 may be accessible by a remote user via a network connection. In some embodiments, the index valuation module 1110 is implemented as a software component (executable by a processor) that can receive data stored in the securities data repository 1140.

The index valuation calculation system 1100 is programmed to perform a series of calculations to transform information received. The index valuation calculation system 1100 is programmed to store the universe of securities in the securities data repository 1140 by using a number of pre-programmed storage methodologies such as: Array{universe of securities (SSᵢ₁, SSᵢ₂, SSᵢ₃ . . . SSᵢₙ)}: Array{(SSᵢ₁, SSᵢ₂, SSᵢ₃ . . . SSᵢₙ)}. The index valuation calculation system 1100 is programmed to select at least one security from the universe of securities in the securities data repository 1140 by using a number of pre-programmed functions such as: Array{(at least one Security (SSᵢₙ)); Array{(SSᵢ₁, SSᵢ₂, SSᵢ₃ . . . SSᵢₙ)}; historical issuance distance (IDᵢₙ); historical issuance notional (Nᵢₙ)}: Array{(SSᵢₙ)}. The index valuation calculation system 1100 is programmed to determine the allocation factor via information from the user input 1160 by using a number of pre-programmed functions such as: function{allocation factor (AFᵢ); Array{(SSᵢₙ)}}: f{(AFᵢ)}. The index valuation calculation system 1100 is programmed to determine the base value via information from the user input 1160 by using a number of pre-programmed functions such as: function{base value (Bᵢ); Array{(SSᵢₙ)}}: f{(Bᵢ)}. The index valuation calculation system 1100 is programmed to derive the issuance cycle for the issuance based securities index from historical issuance distance by using a number of pre-programmed functions such as: function{issuance cycle (ICᵢ); Array{(SSᵢₙ)}}: f{(ICᵢ)}=kᵢ×max (IDᵢ₁, IDᵢ₂, IDᵢ₃ . . . Dᵢₙ) or function{issuance cycle (ICᵢ); Array{(SSᵢₙ)}}: f{(ICᵢ)}=kᵢ×min (IDᵢ₁, IDᵢ₂, IDᵢ₃ . . . Dᵢₙ). The index valuation calculation system 1100 is programmed to determine the allocation period via information from the user input 1160 by using a number of pre-programmed functions such as: function{allocation period (APᵢ); Array{(SSᵢₙ)}}: f{(APᵢ)}. The index valuation calculation system 1100 is programmed to determine the reference time via information from the user input 1160 by using a number of pre-programmed functions such as: function{reference time (RTᵢ); Array{(SSᵢₙ)}}: f{(RTᵢ)}. The index valuation calculation system 1100 is programmed to derive notional weight for each selected security during a reference time from the historical issuance notional by using a number of pre-programmed functions such as: function{notional weight (Wᵢₙ); Array{(SSᵢₙ)}}: f{(Wᵢₙ)}=Nᵢₙ/TNᵢ. The index valuation calculation system 1100 is programmed to derive the expected allocation cycle for each selected security from the allocation period and historical issuance distance by using a number of pre-programmed functions such as: function{allocation cycle (ACᵢₙ); Array{(SSᵢₙ)}}: f{(ACᵢₙ)}=f{(APᵢ)}/IDᵢₙ, or function{allocation cycle (ACᵢₙ); Array{(SSᵢₙ)}}: f{(ACᵢₙ)}=min (f{(APᵢ)}/IDᵢₙ, 1), or function{allocation cycle (ACᵢₙ); Array{(SSᵢₙ)}}: f{(ACᵢₙ)}=max (f{(APᵢ)}/IDᵢₙ, 1). The index valuation calculation system 1100 is programmed to derive allocation weight for each selected security from the notional weight and expected allocation cycle by using a number of pre-programmed functions such as: function{allocation weight (AWᵢₙ); Array{(SSᵢₙ)}}: f{(AWᵢₙ)}=f{(Wᵢₙ)}/f{(ACᵢₙ)}, or function{allocation weight (AWᵢₙ); Array{(SSᵢₙ)}}: f{(AWᵢₙ)}=f{(Wᵢₙ)}/f{(ACᵢₙ)} subject to SUM(f{(AWᵢₙ)})≦1. The index valuation calculation system 1100 is programmed to derive index allocation for each selected security from the allocation weight and allocation factor by using a number of pre-programmed functions such as: function{index allocation (IAᵢₙ); Array{(SSᵢₙ)}}: f{(IAᵢₙ)}=f{(AWᵢₙ)}×f{(AFᵢ)}. The index valuation calculation system 1100 is programmed to calculate the index value by using a number of pre-programmed functions such as: function{index value (IVᵢ); Array{(SSᵢₙ)}}: f{(IVᵢ)}=f{(Bᵢ)}+f{(Bᵢ)}×SUM{((FPᵢₙ−FIPᵢₙ)/FIPᵢₙ)×f{(IAₙ)}}+(UCᵢ×CYᵢ).

### EXAMPLES

### Example A

For the ease of understanding the present invention, an Example A is illustrated for the step 200 to select at least one security (SSᵢₙ) to be included in issuance based securities index from the universe of securities (SSᵢ₁, SSᵢ₂, SSᵢ₃ . . . SSᵢₙ) having historical issuance distance (IDᵢₙ) and historical issuance notional (Nᵢₙ). The Example A is explained in conjunction with Table A1, Table A2 and Table A3 of the present invention.

TABLE A1

| | |
|---|---|
| SSᵢₙ: | Any nominal US Treasury fixed income security with |
| | a maturity of at least 2 years and no longer than |
| | 10 years from the date of issuance. |
| RTᵢ: | From Dec. 1, 2010 until Jan. 1, 2011 |

Table A1 indicates the selected security (SSᵢₙ) of the issuance based securities index as well as the reference time (RTᵢ) as determined by a user. The user determines to create an issuance based securities index that includes any nominal US Treasury fixed income security with a maturity of at least 2 years and no longer than 10 years from the date of issuance. The reference time (RTᵢ) is determined to be from Dec. 1, 2010 until Jan. 1, 2011.

TABLE A2

| | | | | | |
|---|---|---|---|---|---|
| | | | | | Issued |
| | | Historical | Full | | during |
| | | Issuance | Issuance | Included | Reference |
| Issuance | | Notional (Nᵢₙ) | Price (FIPᵢₙ) | in | Time |
| Date | Maturity Date | US Dollars | US Dollars | (SSᵢₙ)? | (RTᵢ)? |

Cash Management Bill

| | | | | | |
|---|---|---|---|---|---|
| Dec. 30, 2010 | Feb. 24, 2011 | 25,000,055,000 | 99.9813 | No | Yes |
| Dec. 23, 2010 | Feb. 17, 2011 | 25,000,885,000 | 99.9798 | No | Yes |
| Dec. 16, 2010 | Feb. 10, 2011 | 25,000,257,500 | 99.9806 | No | Yes |
| Dec. 9, 2010 | Feb. 3, 2011 | 25,000,996,000 | 99.9806 | No | Yes |
| Dec. 8, 2010 | Dec. 15, 2010 | 18,000,200,000 | 99.9972 | No | Yes |
| Dec. 2, 2010 | Jan. 27, 2011 | 25,000,613,200 | 99.9759 | No | Yes |

4-Week US Treasury Bill

| | | | | | |
|---|---|---|---|---|---|
| Dec. 30, 2010 | Jan. 27, 2011 | 31,285,116,900 | 99.9949 | No | Yes |
| Dec. 23, 2010 | Jan. 20, 2011 | 28,782,495,700 | 99.9946 | No | Yes |
| Dec. 16, 2010 | Jan. 13, 2011 | 30,938,320,000 | 99.9934 | No | Yes |
| Dec. 9, 2010 | Jan. 6, 2011 | 27,418,580,500 | 99.9938 | No | Yes |
| Dec. 2, 2010 | Dec. 30, 2010 | 31,286,173,000 | 99.9864 | No | Yes |
| Nov. 26, 2010 | Dec. 23, 2010 | 28,781,976,000 | 99.9888 | No | No |

13-Week US Treasury Bill

| | | | | | |
|---|---|---|---|---|---|
| Dec. 30, 2010 | Mar. 31, 2011 | 29,000,586,500 | 99.9545 | No | Yes |
| Dec. 23, 2010 | Mar. 24, 2011 | 29,000,822,000 | 99.9671 | No | Yes |
| Dec. 16, 2010 | Mar. 17, 2011 | 29,000,593,200 | 99.9646 | No | Yes |
| Dec. 9, 2010 | Mar. 10, 2011 | 29,000,023,700 | 99.9633 | No | Yes |
| Dec. 2, 2010 | Mar. 3, 2011 | 29,000,455,200 | 99.9558 | No | Yes |
| Nov. 26, 2010 | Feb. 24, 2011 | 29,000,526,400 | 99.9650 | No | No |

26-Week US Treasury Bill

| | | | | | |
|---|---|---|---|---|---|
| Dec. 30, 2010 | Jun. 30, 2011 | 28,000,184,400 | 99.8863 | No | Yes |
| Dec. 23, 2010 | Jun. 23, 2011 | 28,000,411,400 | 99.9065 | No | Yes |
| Dec. 16, 2010 | Jun. 16, 2011 | 28,000,540,100 | 99.9039 | No | Yes |
| Dec. 9, 2010 | Jun. 9, 2011 | 28,000,547,700 | 99.9065 | No | Yes |
| Dec. 2, 2010 | Jun. 2, 2011 | 28,000,108,900 | 99.8938 | No | Yes |
| Nov. 26, 2010 | May 26, 2011 | 28,000,668,000 | 99.9020 | No | No |

52-Week US Treasury Bill

| | | | | | |
|---|---|---|---|---|---|
| Dec. 16, 2010 | Dec. 15, 2011 | 22,000,007,900 | 99.7017 | No | Yes |
| Nov. 18, 2010 | Nov. 17, 2011 | 23,000,443,600 | 99.7169 | No | No |
| Oct. 21, 2010 | Oct. 20, 2011 | 24,000,219,300 | 99.7725 | No | No |
| Sep. 23, 2010 | Sep. 22, 2011 | 25,000,307,300 | 99.7321 | No | No |
| Aug. 26, 2010 | Aug. 25, 2011 | 25,000,269,100 | 99.7371 | No | No |
| Jul. 29, 2010 | Jul. 28, 2011 | 25,000,073,200 | 99.7017 | No | No |

2-Year US Treasury Note

| | | | | | |
|---|---|---|---|---|---|
| Dec. 31, 2010 | Dec. 31, 2012 | 36,754,518,900 | 99.7721 | Yes | Yes |
| Nov. 30, 2010 | Nov. 30, 2012 | 36,379,322,800 | 99.9603 | Yes | No |
| Nov. 1, 2010 | Oct. 31, 2010 | 35,717,523,000 | 99.9514 | Yes | No |
| Sep. 30, 2010 | Sep. 30, 2012 | 37,134,262,500 | 99.8687 | Yes | No |
| Aug. 31, 2010 | Aug. 31, 2012 | 37,905,982,800 | 99.7555 | Yes | No |
| Aug. 2, 2010 | Jul. 31, 2012 | 39,247,900,200 | 99.9243 | Yes | No |

3-Year US Treasury Note

| | | | | | |
|---|---|---|---|---|---|
| Dec. 15, 2010 | Dec. 15, 2013 | 32,465,482,400 | 99.6690 | Yes | Yes |
| Nov. 15, 2010 | Nov. 15, 2013 | 32,858,259,800 | 99.7772 | Yes | No |
| Oct. 15, 2010 | Oct. 15, 2013 | 32,281,265,200 | 99.7950 | Yes | No |
| Sep. 15, 2010 | Sep. 15, 2013 | 33,357,124,900 | 99.8816 | Yes | No |
| Aug. 16, 2010 | Aug. 15, 2013 | 36,036,086,600 | 99.7244 | Yes | No |
| Jul. 15, 2010 | Jul. 15, 2013 | 35,009,987,100 | 99.8380 | Yes | No |

5-Year US Treasury Note

| | | | | | |
|---|---|---|---|---|---|
| Dec. 31, 2010 | Dec. 31, 2015 | 36,754,364,500 | 99.8868 | Yes | Yes |
| Nov. 30, 2010 | Nov. 30, 2015 | 36,379,135,100 | 99.8268 | Yes | No |
| Nov. 1, 2010 | Oct. 31, 2015 | 35,717,506,500 | 99.6179 | Yes | No |
| Sep. 30, 2010 | Sep. 30, 2015 | 36,102,696,100 | 99.9517 | Yes | No |
| Aug. 31, 2010 | Aug. 31, 2015 | 36,881,451,400 | 99.4028 | Yes | No |
| Aug. 2, 2010 | Jul. 31, 2015 | 38,215,003,400 | 99.7906 | Yes | No |

7-Year US Treasury Note

| | | | | | |
|---|---|---|---|---|---|
| Dec. 31, 2010 | Dec. 31, 2017 | 30,453,703,600 | 99.4952 | Yes | Yes |
| Nov. 30, 2010 | Nov. 30, 2017 | 30,142,704,500 | 99.9807 | Yes | No |
| Nov. 1, 2010 | Oct. 31, 2017 | 29,594,504,500 | 99.3870 | Yes | No |
| Sep. 30, 2010 | Sep. 30, 2017 | 29,913,659,100 | 99.9021 | Yes | No |
| Aug. 31, 2010 | Aug. 31, 2017 | 29,710,045,700 | 99.2585 | Yes | No |
| Aug. 2, 2010 | Jul. 31, 2017 | 29,952,301,500 | 99.8911 | Yes | No |

10-Year US Treasury Note

| | | | | | |
|---|---|---|---|---|---|
| Dec. 15, 2010 | Nov. 15, 2020 | 21,305,471,900 | 96.1782 | Yes | Yes |
| Nov. 15, 2010 | Nov. 15, 2020 | 24,643,546,400 | 99.9039 | Yes | No |
| Oct. 15, 2010 | Aug. 15, 2020 | 21,184,575,600 | 101.7339 | Yes | No |
| Sep. 15, 2010 | Aug. 15, 2020 | 21,227,191,500 | 99.8289 | Yes | No |
| Aug. 16, 2010 | Aug. 15, 2020 | 25,437,227,300 | 99.0938 | Yes | No |
| Jul. 15, 2010 | May 15, 2020 | 21,005,965,500 | 103.7798 | Yes | No |

30-Year US Treasury Bond

| | | | | | |
|---|---|---|---|---|---|
| Dec. 15, 2010 | Nov. 15, 2040 | 13,189,116,000 | 97.7015 | Yes | Yes |
| Nov. 15, 2010 | Nov. 15, 2040 | 16,429,035,200 | 98.8292 | Yes | No |
| Oct. 15, 2010 | Aug. 15, 2040 | 13,114,248,700 | 101.0400 | Yes | No |
| Sep. 15, 2010 | Aug. 15, 2040 | 13,140,694,200 | 101.2970 | Yes | No |
| Aug. 16, 2010 | Aug. 15, 2040 | 16,958,140,300 | 98.6297 | Yes | No |
| Jul. 15, 2010 | May 15, 2040 | 13,003,707,100 | 105.7790 | Yes | No |

Table A2 illustrates the universe of nominal US Treasury fixed income securities (SSᵢ₁, SSᵢ₂, SSᵢ₃ . . . SSᵢₙ). Herein for exemplary purpose, individual securities from the universe of securities have been indicated. Examples of the individual securities include Cash Management Bills, 4-Week US Treasury Bills, 13-Week US Treasury Bills, 26-Week US Treasury Bills, 52-Week US Treasury Bills, 2-Year US Treasury Notes, 3-Year US Treasury Notes, 5-Year US Treasury Notes, 7-Year US Treasury Notes, 10-Year US Treasury Notes and 30-Year US Treasury Bonds. As shown in Table A2, the last five issuances for each type of security have been indicated. The time between the last two successive issuance dates determines the historical issuance distance (IDᵢₙ). Thus, for the ease of understanding and as shown in Table A2, the historical issuance distance (IDᵢₙ) for the 26 Week US Treasury Bill is 1 week or 0.0192 years (from Dec. 23, 2010 until Dec. 30, 2010) and the historical issuance distance (IDᵢₙ) for the 10-Year US Treasury Note is 1-month or 0.0833 years (from Nov. 15, 2010 until Dec. 15, 2010). According to the selected security (SSᵢₙ) criteria set out in Table A1, only nominal US Treasury fixed income securities having a maturity of at least 2 years and no longer than 10 years from the date of issuance and issued during the reference time From Dec. 1, 2010 until Jan. 1, 2011 are selected for the issuance based securities index construction. As indicated in Table A2, individual securities need to fulfill both the selected security (SSᵢₙ) criteria as well as be issued during the reference time (RTᵢ) so as to be included in Table A3 for issuance based securities index construction purposes.

TABLE A3

| | | | | | |
|---|---|---|---|---|---|
| | | Historical | Full | Historical | |
| | | Issuance | Issuance | Issuance | Notional |
| Issuance | | Notional (Nᵢₙ) | Price (FIPᵢₙ) | Distance | Weight |
| Date | Maturity Date | US Dollars | US Dollars | (IDᵢₙ) | (Wᵢₙ) |

2-Year US Treasury Note

| | | | | | |
|---|---|---|---|---|---|
| Dec. 31, 2010 | Dec. 31, 2012 | 36,754,518,900 | 99.7721 | 1-Month = | 0.2330 |
| | | | | 0.0833 Years | |

3-Year US Treasury Note

| | | | | | |
|---|---|---|---|---|---|
| Dec. 15, 2010 | Dec. 15, 2013 | 32,465,482,400 | 99.6690 | 1-Month = | 0.2058 |
| | | | | 0.0833 Years | |

5-Year US Treasury Note

| | | | | | |
|---|---|---|---|---|---|
| Dec. 31, 2010 | Dec. 31, 2015 | 36,754,364,500 | 99.8868 | 1-Month = | 0.2330 |
| | | | | 0.0833 Years | |

7-Year US Treasury Note

| | | | | | |
|---|---|---|---|---|---|
| Dec. 31, 2010 | Dec. 31, 2017 | 30,453,703,600 | 99.4952 | 1-Month = | 0.1931 |
| | | | | 0.0833 Years | |

10-Year US Treasury Note

| | | | | | |
|---|---|---|---|---|---|
| Dec. 15, 2010 | Nov. 15, 2020 | 21,305,471,900 | 96.1782 | 1-Month = | 0.1351 |
| | | | | 0.0833 Years | |

Table A3 illustrates the details of the securities to be used for the issuance based securities index construction. All securities in Table A3 were issued during the reference time (RTᵢ) between Dec. 1, 2010 and Jan. 1, 2011, and further fulfill the selected security (SSᵢₙ) criteria i.e. they are nominal US Treasury fixed income securities with a maturity of at least 2 years and no longer than 10 year from the date of issuance. Table A3 displays the historical issuance notional (Nᵢₙ), the full issuance price (FIPᵢₙ), the historical issuance distance (IDᵢₙ) and the notional weight (Wᵢₙ) of each security used for index construction. The historical issuance distance (IDᵢₙ) is the time between the last two successive issuance dates and is determined by referring to Table A2. The notional weight (Wᵢₙ) represents the proportion of historical issuance notional (Nᵢₙ) issued relative to the total historical issuance notional (TNᵢ) during the reference time (RTᵢ) as referenced in Table A1. The total historical notional (TNᵢ) for Table A3 is 157,733,541,300 US Dollars (i.e. sum of 36,754,518,900, 32,465,482,400, 36,754,364,500, 30,453,703,600 and 21,305,471,900).

### Example B

For the ease of understanding the present invention, an example of the method 100 or system 60 is explained in conjunction with Table B1 to Table B7 of the present invention.

TABLE B1

| Input | | | |
|---|---|---|---|
| Param- | | | |
| eters | Value | | |
| T₁ | Jan. 1, 2011 | | |
| TA₁ | Jan. 1, 2011 | | |
| SS_{1, 2, 3} | Any nominal US Treasury | = | 2-Year US Treasury Notes |
| | fixed income security | | 3-Year US Treasury Notes |
| | with a maturity of at | | 5-Year US Treasury Notes |
| | least 2 years and no | | 7-Year US Treasury Notes |
| | longer than 10 years | | 10-Year US Treasury Notes |
| | from the date of | | |
| | issuance. | | |

| | |
|---|---|
| k_{1, 2, 3} | 1 |
| m_{1, 2, 3} | 1 |
| p_{1, 2, 3} | 1 |
| AF_{1, 2, 3} | ⅓ = 0.3333 |
| B₁ | 100 |
| B₂ | IV₁ |
| B₃ | IV₂ |
| CY_{1, 2, 3} | 0.0000% |
| TIV₁ | Jan. 31, 2011 |
| TIV₂ | Feb. 28, 2011 |
| TIV₃ | Mar. 31, 2011 |

Table B1 indicates the values of input parameters to be provided by a user. Exemplary values of date of index reference (Tᵢ) and date of index allocation (TAᵢ) are shown as selected by the user in Table 1 i.e. T₁=Jan. 1, 2011 and TA₁=Jan. 1, 2011. The user further chooses a selected security (SS_{1,2,3}) to be all nominal US Treasury fixed income securities issued with a fixed maturity of at least 2 years and no longer than 10 years at the time of issuance. By searching the entire universe of nominal US Treasury fixed income securities, it is determined that 2-year, 3-year, 5-year, 7-year and 10-year US Treasury fixed income securities are to be included in the issuance based securities index (as shown in Example A). Further, to derive issuance cycle (ICᵢ), the issuance cycle multiplier (kᵢ) is determined for all three periods of the issuance based securities index construction as k_{1,2,3} equal to 1. Thereafter, to determine reference time (RTᵢ) and allocation period (APᵢ), pᵢ and mᵢ are determined respectively by the user for the issuance based securities index as p_{1,2,3} and m_{1,2,3} equal to 1. Further, to determine expected allocation cycle (ACᵢₙ) for each selected security (SSᵢₙ), the allocation factor (AFᵢ) is determined to be one-third (⅓) or 0.3333 by the user so as to allocate an equal portion of the initial issuance based securities index to each of the first three allocation periods (AP_{1,2,3}). The base value (Bᵢ) of the issuance based security index is set to 100 for the first period (i.e. B₁=100), and to the index value of the previous period thereafter (i.e. B₂=IV₁ and B₃=IV₂) for ease of interpretation and index construction purposes. The value of cash yield (CYᵢ) for the each allocation period (AP_{1,2,3}) is determined as CY_{1,2,3} equal to 0.0000%. The time of index valuation (TIVᵢ) for the first index value (IV₁), second index value (IV₂) and third index value (IV₃) calculation is determined as TIVᵢ=Jan. 31, 2011, TIV₂=Feb. 28, 2011 and TIV₃=Mar. 31, 2011.

TABLE B2

| | |
|---|---|
| Output | |
| Param- | |
| eters | Value |

| | | |
|---|---|---|
| ID_{1, 2, 3} | ID₁ | ID₁(2-Year US Treasury Note)₁ = 1 month = 0.0833 Years |
| | | ID₁(3-Year US Treasury Note)₁ = 1 month = 0.0833 Years |
| | | ID₁(5-Year US Treasury Note)₁ = 1 month = 0.0833 Years |
| | | ID₁(7-Year US Treasury Note)₁ = 1 month = 0.0833 Years |
| | | ID₁(10-Year US Treasury Note)₁ = 1 month = 0.0833 Years |
| | ID₂ | ID₂(2-Year US Treasury Note)₂ = 1 month = 0.0833 Years |
| | | ID₂(3-Year US Treasury Note)₂ = 1 month = 0.0833 Years |
| | | ID₂(5-Year US Treasury Note)₂ = 1 month = 0.0833 Years |
| | | ID₂(7-Year US Treasury Note)₂ = 1 month = 0.0833 Years |
| | | ID₂(10-Year US Treasury Note)₂ = 1 month = 0.0833 Years |
| | ID₃ | ID₃(2-Year US Treasury Note)₃ = 1 month = 0.0833 Years |
| | | ID₃(3-Year US Treasury Note)₃ = 1 month = 0.0833 Years |
| | | ID₃(5-Year US Treasury Note)₃ = 1 month = 0.0833 Years |
| | | ID₃(7-Year US Treasury Note)₃ = 1 month = 0.0833 Years |
| | | ID₃(10-Year US Treasury Note)₃ = 1 month = 0.0833 Years |

| | |
|---|---|
| IC_{1, 2, 3} | IC₁ = 1 month = 0.0833 Years |
| | IC₂ = 1 month = 0.0833 Years |
| | IC₃ = 1 month = 0.0833 Years |

Table B2 indicates the values of the historical issuance distance (IDᵢₙ) for each selected security (SSᵢₙ) and issuance cycle (ICᵢ) for the issuance based securities index. The value of historical issuance distance (IDᵢₙ) for each selected security (SSᵢₙ) is determined in order to derive issuance cycle (ICᵢ) of the issuance based securities index. The historical issuance distance (ID_{1,2,3}) for each selected security (SS_{1,2,3}) is 1 month or 0.0833 years. The value of issuance cycle (IC_{1,2,3}) is derived from the values of historical issuance distance (ID_{1,2,3}) and k_{1,2,3}. Thus, from the equation ICᵢ=kᵢ×max(ID₁, ID₂, ID₃ . . . IDᵢₙ); IC₁=1 month=0.0833 Years, IC₂=1 month=0.0833 Years and IC₃=1 month=0.0833 Years.

TABLE B3

| | |
|---|---|
| Output | |
| Param- | |
| eters | Value |

| RT_{1, 2, 3} | RT₁ = from Dec. 1, 2010 to Jan. 1, 20111 | |
|---|---|---|
| | RT₂ = from Jan. 1, 2011 to Feb. 1, 20111 | |
| | RT₃ = from Feb. 1, 2011 to Mar. 1, 20111 | |
| AP_{1, 2, 3} | AP₁ = from Jan. 1, 2011 to Feb. 1, 2011 = 1 month = 0.0833 Years | |
| | AP₂ = from Feb. 1, 2011 to Mar. 1, 2011 = 1 month = 0.0833 Years | |
| | AP₃ = from Mar. 1, 2011 to Apr. 1, 2011 = 1 month = 0.0833 Years | |
| N_{1, 2, 3} | N₁ | N₁(2-Year US Treasury Note)₁ = 36,754,518,900 US Dollars |
| | | N₁(3-Year US Treasury Note)₁ = 32,465,482,400 US Dollars |
| | | N₁(5-Year US Treasury Note)₁ = 36,754,364,500 US Dollars |
| | | N₁(7-Year US Treasury Note)₁ = 30,453,703,600 US Dollars |
| | | N₁(10-Year US Treasury Note)₁ = 21,305,471,900 US Dollars |
| | N₂ | N₂(2-Year US Treasury Note)₂ = 35,697,586,000 US Dollars |
| | | N₂(3-Year US Treasury Note)₂ = 32,70,309,000 US Dollars |
| | | N₂(5-Year US Treasury Note)₂ = 35,697,519,500 US Dollars |
| | | N₂(7-Year US Treasury Note)₂ = 29,577,900,100 US Dollars |
| | | N₂(10-Year US Treasury Note)₂ = 21,460,236,400 US Dollars |
| | N₃ | N₃(2-Year US Treasury Note)₃ = 36,922,671,800 US Dollars |
| | | N₃(3-Year US Treasury Note)₃ = 32,734,227,300 US Dollars |
| | | N₃(5-Year US Treasury Note)₃ = 36,922,649,000 US Dollars |
| | | N₃(7-Year US Treasury Note)₃ = 30,593,053,300 US Dollars |
| | | N₃(10-Year US Treasury Note)₃ = 24,550,680,100 US Dollars |

Table B3 indicates the values of reference time (RTᵢ), allocation period (APᵢ) and historical issuance notional (Nᵢₙ). The reference time (RTᵢ) for each period of the issuance based securities index construction such as RT₁, RT₂ and RT₃ is determined from the equation (Tᵢ−(pᵢ×ICᵢ)) until (Tᵢ), wherein T₁ is Jan. 1, 2011 and p_{1,2,3} is 1; thus reference time (RTᵢ) such as RT₁ is from Dec. 1, 2010 until Jan. 1, 2011, RT₂ is from Jan. 1, 2011 until Feb. 1, 2011, and RT₃ is from Feb. 1, 2011 until Mar. 1, 2011. Similarly, for each period of the issuance based securities index construction the allocation period (APᵢ) is determined from (TAᵢ) until (TAᵢ+(mᵢ×ICᵢ)), wherein TA₁ is equal to Jan. 1, 2011, m_{1,2,3} is equal to 1 and IC_{1,2,3} is equal to 1 month i.e. 0.8333 years. The respective allocation periods (APᵢ) for the issuance based securities index construction are AP₁ which is from Jan. 1, 2011 until Feb. 1, 2011, AP₂ which is from Feb. 1, 2011 until Mar. 1, 2011 and AP₃ which is from Mar. 1, 2011 until Apr. 1, 2011. The historical issuance notional (N_{1,2,3}) is determined for each selected security (SS_{1,2,3}) during its respective reference time (RT_{1,2,3}) and the values of historical issuance notional (N_{1,2,3}) are indicated in Table B3.

TABLE B4

| | |
|---|---|
| Output | |
| Param- | |
| eters | Value |

| | | |
|---|---|---|
| TN_{1, 2, 3} | | TN₁ = 157,733,541,300 US Dollars |
| | | TN₂ = 155,134,551,000 US Dollars |
| | | TN₃ = 161,723,281,500 US Dollars |
| W_{1, 2, 3} | W₁ | W₁(2-Year US Treasury Note)₁ = 0.2330 |
| | | W₁(3-Year US Treasury Note)₁ = 0.2058 |
| | | W₁(5-Year US Treasury Note)₁ = 0.2330 |
| | | W₁(7-Year US Treasury Note)₁ = 0.1931 |
| | | W₁(10-Year US Treasury Note)₁ = 0.1351 |
| | W₂ | W₂(2-Year US Treasury Note)₂ = 0.2301 |
| | | W₂(3-Year US Treasury Note)₂ = 0.2108 |
| | | W₂(5-Year US Treasury Note)₂ = 0.2301 |
| | | W₂(7-Year US Treasury Note)₂ = 0.1907 |
| | | W₂(10-Year US Treasury Note)₂ = 0.1383 |
| | W₃ | W₃(2-Year US Treasury Note)₃ = 0.2283 |
| | | W₃(3-Year US Treasury Note)₃ = 0.2024 |
| | | W₃(5-Year US Treasury Note)₃ = 0.2283 |
| | | W₃(7-Year US Treasury Note)₃ = 0.1892 |
| | | W₃(10-Year US Treasury Note)₃ = 0.1518 |

Table B4 indicates the values of total historical issuance notional (TNᵢ) and notional weight (Wᵢₙ). The total historical issuance notional (TN_{1,2,3}) for each of the periods of the issuance based securities index is determined as the sum of all historical issuance notional (N_{1,2,3}) (as indicated in Table B3) for each respective period of the issuance based securities index. To derive notional weight (W_{1,2,3}) for each selected security (SS_{1,2,3}) step 600 (reference to FIG. 3) is performed using equation Wᵢₙ=Nᵢₙ/TNᵢ, thus the values of notional weight (W_{1,2,3}) are determined and the values are indicated in Table B4.

TABLE B5

| | |
|---|---|
| Output | |
| Param- | |
| eters | Value |

| | | |
|---|---|---|
| AC_{1, 2, 3} | AC₁ | AC₁(2-Year US Treasury Note)₁ = 1 |
| | | AC₁(3-Year US Treasury Note)₁ = 1 |
| | | AC₁(5-Year US Treasury Note)₁ = 1 |
| | | AC₁(7-Year US Treasury Note)₁ = 1 |
| | | AC₁(10-Year US Treasury Note)₁ = 1 |
| | AC₂ | AC₂(2-Year US Treasury Note)₂ = 1 |
| | | AC₂(3-Year US Treasury Note)₂ = 1 |
| | | AC₂(5-Year US Treasury Note)₂ = 1 |
| | | AC₂(7-Year US Treasury Note)₂ = 1 |
| | | AC₂(10-Year US Treasury Note)₂ = 1 |
| | AC₃ | AC₃(2-Year US Treasury Note)₃ = 1 |
| | | AC₃(3-Year US Treasury Note)₃ = 1 |
| | | AC₃(5-Year US Treasury Note)₃ = 1 |
| | | AC₃(7-Year US Treasury Note)₃ = 1 |
| | | AC₃(10-Year US Treasury Note)₃ = 1 |
| AW_{1, 2, 3} | AW₁ | AW₁(2-Year US Treasury Note)₁ = 0.2330 |
| | | AW₁(3-Year US Treasury Note)₁ = 0.2058 |
| | | AW₁(5-Year US Treasury Note)₁ = 0.2330 |
| | | AW₁(7-Year US Treasury Note)₁ = 0.1931 |
| | | AW₁(10-Year US Treasury Note)₁ = 0.1351 |
| | AW₂ | AW₂(2-Year US Treasury Note)₂ = 0.2301 |
| | | AW₂(3-Year US Treasury Note)₂ = 0.2108 |
| | | AW₂(5-Year US Treasury Note)₂ = 0.2301 |
| | | AW₂(7-Year US Treasury Note)₂ = 0.1907 |
| | | AW₂(10-Year US Treasury Note)₂ = 0.1383 |
| | AW₃ | AW₃(2-Year US Treasury Note)₃ = 0.2283 |
| | | AW₃(3-Year US Treasury Note)₃ = 0.2024 |
| | | AW₃(5-Year US Treasury Note)₃ = 0.2283 |
| | | AW₃(7-Year US Treasury Note)₃ = 0.1892 |
| | | AW₃(10-Year US Treasury Note)₃ = 0.1518 |

Table B5 indicates the values of expected allocation cycle (ACᵢₙ) and allocation weight (AWᵢₙ) for each selected security (SSᵢₙ). The expected allocation cycle (ACᵢₙ) may be derived either from the equation 700a or 700b or 700c. Herein, for exemplary reference the expected allocation cycle (ACᵢₙ) is derived from equation 700a i.e. ACᵢₙ=APᵢ/IDᵢₙ. Taking the values of allocation period (AP_{1,2,3}) and historical issuance distance (ID_{1,2,3}) from Table B3 and Table B2 respectively; the expected allocation cycle (AC_{1,2,3}) for each selected security (SSᵢₙ) is derived and the values are as indicated in Table B5. The allocation weight (AWᵢₙ) may be derived from either equation 800a or 800b. Herein, for exemplary reference the allocation weight (AWᵢₙ) is derived from equation 800a i.e. AWᵢₙ=Wᵢₙ/ACᵢₙ. Thus, taking values of notional weight (W_{1,2,3}) from Table B4 and expected allocation cycle (AC_{1,2,3}) from Table B5; allocation weight (AW_{1,2,3}) for each selected security (SS_{1,2,3}) is derived and the values are indicated in Table B5.

TABLE B6

| | |
|---|---|
| Output | |
| Param- | |
| eters | Value |

| | | |
|---|---|---|
| IA_{1, 2, 3} | IA₁ | IA₁(2-Year US Treasury Note)₁ = 0.0777 |
| | | IA₁(3-Year US Treasury Note)₁ = 0.0686 |
| | | IA₁(5-Year US Treasury Note)₁ = 0.0777 |
| | | IA₁(7-Year US Treasury Note)₁ = 0.0644 |
| | | IA₁(10-Year US Treasury Note)₁ = 0.0450 |
| | IA₂ | IA₂(2-Year US Treasury Note)₂ = 0.0767 |
| | | IA₂(3-Year US Treasury Note)₂ = 0.0703 |
| | | IA₂(5-Year US Treasury Note)₂ = 0.0767 |
| | | IA₂(7-Year US Treasury Note)₂ = 0.0636 |
| | | IA₂(10-Year US Treasury Note)₂ = 0.0461 |
| | IA₃ | IA₃(2-Year US Treasury Note)₃ = 0.0761 |
| | | IA₃(3-Year US Treasury Note)₃ = 0.0675 |
| | | IA₃(5-Year US Treasury Note)₃ = 0.0761 |
| | | IA₃(7-Year US Treasury Note)₃ = 0.0631 |
| | | IA₃(10-Year US Treasury Note)₃ = 0.0506 |

Table B6 indicates the value of index allocation (IAᵢₙ) for each selected security (SSᵢₙ). The index allocation (IAᵢₙ) for each selected security (SSᵢₙ) is determined from step 900 (reference to FIG. 6) and is derived from equation IAᵢₙ=AWᵢₙ×AFᵢ. Taking values of allocation weight (AW_{1,2,3}) for each selected security (SSᵢₙ) from Table B5 and allocation factor (AF_{1,2,3}) as indicated in Table B1; the value of index allocation (IA_{1,2,3}) for each selected security (SS_{1,2,3}) is derived and indicated in Table B6.

TABLE B7

| Output | | |
|---|---|---|
| Param- | | |
| eters | Value | |
| FIP_{1, 2, 3} | FIP₁ | FIP₁(2-Year US Treasury Note)₁ = 99.9504 |
| | | FIP₁(3-Year US Treasury Note)₁ = 99.9206 |
| | | FIP₁(5-Year US Treasury Note)₁ = 99.8061 |
| | | FIP₁(7-Year US Treasury Note)₁ = 99.2468 |
| | | FIP₁(10-Year US Treasury Note)₁ = 94.1215 |
| | FIP₂ | FIP₂(2-Year US Treasury Note)₂ = 99.7622 |
| | | FIP₂(3-Year US Treasury Note)₂ = 99.7099 |
| | | FIP₂(5-Year US Treasury Note)₂ = 99.6937 |
| | | FIP₂(7-Year US Treasury Note)₂ = 99.3443 |
| | | FIP₂(10-Year US Treasury Note)₂ = 99.6676 |
| | FIP₃ | FIP₃(2-Year US Treasury Note)₃ = 99.9228 |
| | | FIP₃(3-Year US Treasury Note)₃ = 99.8592 |
| | | FIP₃(5-Year US Treasury Note)₃ = 99.9530 |
| | | FIP₃(7-Year US Treasury Note)₃ = 99.8741 |
| | | FIP₃(10-Year US Treasury Note)₃ = 101.3250 |
| FP_{1, 2, 3} | FP₁ | FP₁(2-Year US Treasury Note)₁ = 100.1094 |
| | | FP₁(3-Year US Treasury Note)₁ = 100.1442 |
| | | FP₁(5-Year US Treasury Note)₁ = 100.2500 |
| | | FP₁(7-Year US Treasury Note)₁ = 99.4600 |
| | | FP₁(10-Year US Treasury Note)₁ = 94.3184 |
| | FP₂ | FP₂(2-Year US Treasury Note)₁ = 99.9975 |
| | | FP₂(3-Year US Treasury Note)₁ = 99.7915 |
| | | FP₂(5-Year US Treasury Note)₁ = 99.6347 |
| | | FP₂(7-Year US Treasury Note)₁ = 99.0130 |
| | | FP₂(10-Year US Treasury Note)₁ = 94.2714 |
| | | FP₂(2-Year US Treasury Note)₂ = 99.8700 |
| | | FP₂(3-Year US Treasury Note)₂ = 100.2949 |
| | | FP₂(5-Year US Treasury Note)₂ = 99.9492 |
| | | FP₂(7-Year US Treasury Note)₂ = 99.4200 |
| | | FP₂(10-Year US Treasury Note)₂ = 101.8333 |
| | FP₃ | FP₃(2-Year US Treasury Note)₁ = 99.8441 |
| | | FP₃(3-Year US Treasury Note)₁ = 99.5772 |
| | | FP₃(5-Year US Treasury Note)₁ = 99.3860 |
| | | FP₃(7-Year US Treasury Note)₁ = 99.8378 |
| | | FP₃(10-Year US Treasury Note)₁ = 94.1662 |
| | | FP₃(2-Year US Treasury Note)₂ = 99.7326 |
| | | FP₃(3-Year US Treasury Note)₂ = 100.0819 |
| | | FP₃(5-Year US Treasury Note)₂ = 99.6556 |
| | | FP₃(7-Year US Treasury Note)₂ = 99.3017 |
| | | FP₃(10-Year US Treasury Note)₂ = 101.7375 |
| | | FP₃(2-Year US Treasury Note)₃ = 99.9063 |
| | | FP₃(3-Year US Treasury Note)₃ = 100.8543 |
| | | FP₃(5-Year US Treasury Note)₃ = 100.1100 |
| | | FP₃(7-Year US Treasury Note)₃ = 99.8800 |
| | | FP₃(10-Year US Treasury Note)₃ = 101.7375 |

| | |
|---|---|
| UC_{1, 2, 3} | UC₁ = 67.0039 |
| | UC₂ = 33.7897 |
| | UC₃ = 0.4162 |
| IV_{1, 2, 3} | IV₁ = 100.0845 |
| | IV₂ = 100.1465 |
| | IV₃ = 100.0562 |

Table B7 indicates the value of full issuance price (FIPᵢₙ) and full price (FPᵢₙ) for each selected security (SSᵢₙ). Further it indicates the value of unallocated cash (UCᵢ) and index value (IVᵢ) for each period i of the issuance based securities index. The value of full issuance price (FIP_{1,2,3}) for each selected security (SS_{1,2,3}) is indicated in Table B7. The full price (FPᵢₙ) for each selected security (SSᵢₙ) is determined at the time of index valuation (TIVᵢ). The values of time of index valuation (TIV_{1,2,3}) are indicated in Table B1 and thus the values of Full Price (FP_{1,2,3}) for each selected security (SSᵢₙ) are determined and indicated in Table B7. The base value (Bᵢ) of the issuance based securities index is determined from Table B1. The unallocated cash (UC_{1,2,3}) is determined for each period of the issuance based securities index as indicated in Table B7. In another embodiment of the present invention, the unallocated cash (UCᵢ) may be negative if funds are borrowed or leverage is used. If unallocated cash (UCᵢ) is negative, the cash yield (CYᵢ) represents the interest rate at which funds are borrowed. Thus all the values are put into the equation IVᵢ=Bᵢ+Bᵢ×Σ{((FPᵢₙ−FIPᵢₙ)/FIPᵢₙ)×IAᵢₙ}+(UCᵢ×CYᵢ) for each period of the issuance based securities index and the index value (IV_{1,2,3}) is determined and indicated in Table B7.

### Example C

For the ease of understanding of the present invention, an Example C is illustrated for index value (IVᵢ) calculation purposes and is explained in detail in conjunction with Table C1 of the present invention.

TABLE C1

| | | Index Value (IVᵢ) | | | | | |
|---|---|---|---|---|---|---|---|
| Index | | Mar. 31, | Apr. 1, | Apr. 4, | Apr. 5, | Apr. 6, | Apr. 7, |
| Allocation | Index | 2011 | 2011 | 2011 | 2011 | 2011 | 2011 |
| (IAᵢₙ) & Full | Allocation | 100.0562 | 100.1309 | 100.3378 | 100.0543 | 99.8234 | 99.9520 |
| Price (FPᵢₙ) | (IAᵢₙ) | Full Price (FPᵢₙ) | | | | | |
| (2-Year US | 0.0777 | 99.8441 | 99.9161 | 99.9877 | 99.8996 | 99.8739 | 99.9734 |
| Treasury Note)₁ | | | | | | | |
| (3-Year US | 0.0686 | 99.5772 | 99.6499 | 99.8082 | 99.6110 | 99.4938 | 99.6565 |
| Treasury Note)₁ | | | | | | | |
| (5-Year US | 0.0777 | 99.3860 | 99.5115 | 99.7881 | 99.4436 | 99.2091 | 99.3946 |
| Treasury Note)₁ | | | | | | | |
| (7-Year US | 0.0644 | 98.8378 | 99.0151 | 99.3068 | 98.9141 | 98.5313 | 98.6886 |
| Treasury Note)₁ | | | | | | | |
| (10-Year US | 0.0450 | 94.1662 | 94.3434 | 94.5552 | 94.0824 | 93.6097 | 93.5869 |
| Treasury Note)₁ | | | | | | | |
| (2-Year US | 0.0767 | 99.7326 | 99.7843 | 99.8594 | 99.7711 | 99.7228 | 99.8245 |
| Treasury Note)₂ | | | | | | | |
| (3-Year US | 0.0703 | 100.0819 | 100.1254 | 100.3057 | 100.1192 | 100.0127 | 100.1661 |
| Treasury Note)₂ | | | | | | | |
| (5-Year US | 0.0767 | 99.6556 | 99.7548 | 100.0521 | 99.7079 | 99.4737 | 99.6694 |
| Treasury Note)₂ | | | | | | | |
| (7-Year US | 0.0636 | 99.3017 | 99.4491 | 99.7215 | 99.3930 | 98.9565 | 99.1140 |
| Treasury Note)₂ | | | | | | | |
| (10-Year US | 0.0461 | 101.7375 | 101.9037 | 102.1370 | 101.6313 | 101.1257 | 101.1357 |
| Treasury Note)₂ | | | | | | | |
| (2-Year US | 0.0761 | 99.9063 | 99.8770 | 99.9770 | 99.8696 | 99.8482 | 99.9127 |
| Treasury Note)₃ | | | | | | | |
| (3-Year US | 0.0675 | 99.8543 | 99.9477 | 100.1379 | 99.9413 | 99.8247 | 99.9881 |
| Treasury Note)₃ | | | | | | | |
| (5-Year US | 0.0761 | 100.1100 | 100.0161 | 100.2946 | 99.9407 | 99.6969 | 99.9030 |
| Treasury Note)₃ | | | | | | | |
| (7-Year US | 0.0631 | 99.8800 | 99.8479 | 100.1314 | 99.7293 | 99.3671 | 99.5250 |
| Treasury Note)₃ | | | | | | | |
| (10-Year US | 0.0506 | 101.7375 | 101.9037 | 102.1370 | 101.6313 | 101.1257 | 101.1357 |
| Treasury Note)₃ | | | | | | | |
| Unallocated | | 0.4162 | 0.4162 | 0.4162 | 0.4162 | 0.4162 | 0.4162 |
| Cash (UCᵢ) | | | | | | | |

Table C1 indicates a sample index value (IVᵢ) calculation of an issuance based securities index as explained in method 100 or system 60 performed on a daily basis as determined by a user. In a preferred embodiment of the present invention, and as a continuation to example B, exemplary index values (IVᵢ) for the issuance based securities index are calculated for the Mar. 31, 2011, Apr. 1, 2011, Apr. 4, 2011, Apr. 5, 2011, Apr. 6, 2011 and Apr. 7, 2011 dates. As indicated in Table C1, every security included in the issuance based securities index has its respective index allocation (IAᵢₙ). The index allocation (IAᵢₙ) in addition to the full price (FPᵢₙ), as determined by the market for each security, as well as the unallocated cash (UCᵢ) of the issuance based securities index are applied to the index value (IVᵢ) equation IVᵢ=Bᵢ+Bᵢ×Σ{((FPᵢₙ−FIPᵢₙ)/FIPᵢₙ)×IAᵢₙ}+(UCᵢ×CYᵢ). Given that Table C1 aims to compute a daily index value (IVᵢ) for the issuance based securities index, the base value (Bᵢ) is set equal to the previous day's index value (IVᵢ). This daily computation of the index value (IVᵢ) of the issuance based securities index allows the user to track the performance of the issuance based securities index on a daily basis, thus enabling the user to track the constructed portfolio benchmark with respect to his investment goals on a daily basis and therefore gain better oversight of his respective investment performance.

The present invention offers various advantages to a user by constructing an issuance based securities index rather than a traditional securities index. Further, it offers an easy to track as well as extremely cost-effective index to replicate. Unlike many other securities indices, the present invention does not require the user to adapt his tracking behavior to the index, but rather allows a user to allocate the issuance based securities index in such a manner as to best suit his investment objectives. Unlike other securities indices, the present invention does not require the continuous re-balancing of securities included in the issuance based securities index upon addition of new securities but rather only allocates to newly issued or re-issued securities, thus minimizing the amount of securities entering and exiting the issuance based securities index. Further, the user will be able to allocate the securities at the time of issuance just like the issuance based securities index, therefore eliminating a major source of performance tracking variance and substantially reducing transaction costs. As already mentioned, a user, unlike with many traditional securities indices, may define the present invention to his desired investment objectives, matching the desired allocation period (APᵢ) to his desired investment period, spreading the initial investment according to his desired allocation factor (AFᵢ), determining the selected security (SSᵢₙ) so as to fit the user's investment objective, and re-invest the proceeds or unallocated cash (UCᵢ) through a methodology and at a cash yield (CYᵢ) that best suits his investment theme and product universe.

Having described this invention with regard to specific embodiments, it is to be understood that the description is not meant as a limitation since further variations or modifications may be apparent or may suggest themselves to those skilled in the art. For example, the provided method may easily be modified to generate other types of issuance based securities indices. It is intended that the present application cover such variations and modifications as fall within the scope of the appended claims.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A computer implemented method for creating an issuance based securities index for period i, said method comprising the steps of:
a) storing in a computer memory at least one selected security (SSᵢₙ) to be included in the issuance based securities index from the universe of securities (SSᵢ₁, SSᵢ₂, SSᵢ₃ . . . SSᵢₙ), said selected security comprising a historical issuance distance (IDᵢₙ) and historical issuance notional (Nᵢₙ);
b) programmatically determining allocation factor (AFᵢ) and base value (Bᵢ) for the issuance based securities index;
c) programmatically deriving issuance cycle (ICᵢ) for the issuance based securities index from historical issuance distance (IDᵢₙ);
d) programmatically determining allocation period (APᵢ) and reference time (RTᵢ) for the issuance based securities index;
e) programmatically deriving notional weight (Wᵢₙ) for each selected security (SSᵢₙ) during a reference time (RTᵢ) from historical issuance notional (Nᵢₙ);
f) programmatically deriving expected allocation cycle (ACᵢₙ) for each selected security (SSᵢₙ), said step of expected allocation cycle (ACᵢₙ) is calculated from the allocation period (APᵢ) and historical issuance distance (IDᵢₙ);
g) programmatically deriving allocation weight (AWᵢₙ) for each selected security (SSᵢₙ), said step of deriving allocation weight (AWᵢₙ) is calculated from the notional weight (Wᵢₙ) and expected allocation cycle (ACᵢₙ);
h) programmatically deriving index allocation (IAᵢₙ) for each selected security (SSᵢₙ), said step of deriving index allocation (IAᵢₙ) is calculated from the allocation weight (AWᵢₙ) and allocation factor (AFᵢ);
i) programmatically calculating index value (IVᵢ) from equation:
IVᵢ=Bᵢ+Bᵢ×Σ{((FPᵢₙ−FIPᵢₙ)/FIPᵢₙ)×IAᵢₙ}+(UCᵢ×CYᵢ)
wherein FPᵢₙ is the full price of each selected security (SSᵢₙ) and FIPᵢₙ is the full issuance price of each selected security (SSᵢₙ) and UCᵢ is the unallocated cash of the issuance based securities index and CYᵢ is interest rate earned on the unallocated cash (UCᵢ).

2. The method of claim 1 wherein the issuance cycle (ICᵢ) is programmatically derived from equation ICᵢ=kᵢ×max (IDᵢ₁, IDᵢ₂, IDᵢ₃ . . . Dᵢₙ), wherein kᵢ is a positive number.

3. The method of claim 1 wherein the issuance cycle (ICᵢ) is programmatically derived from equation ICᵢ=kᵢ×min (IDᵢ₁, IDᵢ₂, IDᵢ₃ . . . IDᵢₙ), wherein kᵢ is a positive number.

4. The method of claim 1 wherein the notional weight (Wᵢₙ) is programmatically derived from equation Wᵢₙ=Nᵢₙ/TNᵢ; wherein Nᵢₙ is the historical issuance notional issued during RTᵢ for each selected security (SSᵢₙ), and TNᵢ is the total historical issuance notional issued during RTᵢ for each selected security (SSᵢₙ), and RTᵢ is defined as the reference time from (Tᵢ−(pᵢ×ICᵢ)) until (Tᵢ) wherein pᵢ is a positive number and Tᵢ is the date of index reference.

5. The method of claim 1 wherein the expected allocation cycle (ACᵢₙ) is programmatically derived from equation ACᵢₙ=APᵢ/IDᵢₙ; wherein APᵢ is defined as the allocation period from (TAᵢ) until (TAᵢ+(mᵢ×ICᵢ)) wherein mᵢ is a positive number and TAᵢ is the date of index allocation.

6. The method of claim 1 wherein the expected allocation cycle (ACᵢₙ) is programmatically derived from equation ACᵢₙ=min (APᵢ/IDᵢₙ, 1); wherein APᵢ is defined as the allocation period from (TAᵢ) until (TAᵢ+(mᵢ×ICᵢ)) wherein mᵢ is a positive number and TAᵢ is the date of index allocation.

7. The method of claim 1 wherein the expected allocation cycle (ACᵢₙ) is programmatically derived from equation ACᵢₙ=max (APᵢ/Dᵢₙ, 1); wherein APᵢ is defined as the allocation period from (TAᵢ) until (TAᵢ+(mᵢ×ICᵢ)) wherein mᵢ is a positive number and TAᵢ is the date of index allocation.

8. The method of claim 1 wherein the allocation weight (AWᵢₙ) is programmatically derived from equation AWᵢₙ=Wᵢₙ/ACᵢₙ.

9. The method of claim 1 wherein the allocation weight (AWᵢₙ) is programmatically derived from equation AWᵢₙ=Wᵢₙ/ACᵢₙ subject to ΣAWᵢₙ≦1.

10. The method of claim 1 wherein the index allocation (IAᵢₙ) is programmatically derived from equation IAᵢₙ=AWᵢₙ×AFᵢ.

11. A computer implemented method for creating an issuance based securities index for period i, said method comprising the steps of:
a) storing in a computer memory at least one selected security (SSᵢₙ) to be included in the issuance based securities index from the universe of securities (SSᵢ₁, SSᵢ₂, SSᵢ₃ . . . SSᵢₙ), said selected security comprising a historical issuance distance (IDᵢₙ) and historical issuance notional (Nᵢₙ);
b) programmatically determining allocation factor (AFᵢ) and base value (Bᵢ) for the issuance based securities index;
c) programmatically deriving issuance cycle (ICᵢ) for the issuance based securities index from equation: ICᵢ=kᵢ×max (IDᵢ₁, IDᵢ₂, IDᵢ₃ . . . IDᵢₙ), wherein kᵢ is a positive number;
d) programmatically determining allocation period (APᵢ) and reference time (RTᵢ) for the issuance based securities index;
e) programmatically deriving notional weight (Wᵢₙ) for each selected security (SSᵢₙ) during reference time (RTᵢ) from equation: Wᵢₙ=Nᵢₙ/TNᵢ; wherein Nᵢₙ is the notional amount issued during RTᵢ for each selected security (SSᵢₙ), and TNᵢ is the total notional amount issued during RTᵢ for each selected security in (SSᵢₙ);
f) programmatically deriving expected allocation cycle (ACᵢₙ) for each selected security (SSᵢₙ) from equation: ACᵢₙ=APᵢ/IDᵢₙ;
g) programmatically deriving allocation weight (AWᵢₙ) for each selected security (SSᵢₙ) from equation: AWᵢₙ=Wᵢₙ/ACᵢₙ;
h) programmatically deriving index allocation (IAᵢₙ) for each selected security (SSᵢₙ) from equation: IAᵢₙ=AWᵢₙ×AFᵢ;
i) programmatically calculating index value (IVᵢ) from equation:
IVᵢ=Bᵢ+Bᵢ×Σ{((FPᵢₙ−FIPᵢₙ)/FIPᵢₙ)×IAᵢₙ}+(UCᵢ×CYᵢ)
wherein FPᵢₙ is the full price of each selected security (SSᵢₙ) and FIPᵢₙ is the full issuance price of each selected security (SSᵢₙ) and UCᵢ is the unallocated cash of the issuance based securities index and CYᵢ is interest rate earned on the unallocated cash (UCᵢ).

12. The method of claim 11 wherein the reference time (RTᵢ) is defined as the reference time from (Tᵢ−(pᵢ×ICᵢ)) until (Tᵢ) wherein pᵢ is a positive number and Tᵢ is the date of index reference.

13. The method of claim 11 wherein the allocation period (APᵢ) is defined as the period from (TAᵢ) until (TAᵢ+(mᵢ×ICᵢ)) wherein mᵢ is a positive number and TAᵢ is the date of index allocation.

14. An issuance based securities index system for a period i comprising:
a) at least one database to store and permit retrieval of data of the universe of securities (SSᵢ₁, SSᵢ₂, SSᵢ₃ . . . SSᵢₙ);
b) at least one processor connected to said database, said processor is configured to:
(i) accept at least one selected security (SSᵢₙ) to be included in the issuance based securities index from the universe of securities (SSᵢ₁, SSᵢ₂, SSᵢ₃ . . . SSᵢₙ), said selected security comprising a historical issuance distance (IDᵢₙ) and historical issuance notional (Nᵢₙ);
(ii) determine allocation factor (AFᵢ), and base value (Bᵢ) for the issuance based securities index;
(iii) derive issuance cycle (ICᵢ) for the issuance based securities index from historical issuance distance (IDᵢₙ);
(iv) determine allocation period (APᵢ) and reference time (RTᵢ) for the issuance based securities index;
(v) derive notional weight (Wᵢₙ) for each selected security (SSᵢₙ) during a reference time (RTᵢ) from historical issuance notional (Nᵢₙ);
(vi) derive expected allocation cycle (ACᵢₙ) for each selected security (SSᵢₙ), said expected allocation cycle (ACᵢₙ) is calculated from the allocation period (APᵢ) and historical issuance distance (IDᵢₙ);
(vii) derive allocation weight (AWᵢₙ) for each selected security (SSᵢₙ), said allocation weight (AWᵢₙ) is calculated from the notional weight (Wᵢₙ) and expected allocation cycle (ACᵢₙ);
(viii) derive index allocation (IAᵢₙ) for each selected security (SSᵢₙ), said index allocation (IAᵢₙ) is calculated from the allocation weight (AWᵢₙ) and allocation factor (AFᵢ); and
(ix) calculate index value (IVᵢ) from the equation:
IVᵢ=Bᵢ+Bᵢ×Σ{((FPᵢₙ−FIPᵢₙ)/FIPᵢₙ)×IAᵢₙ}+(UCᵢ×CYᵢ)
wherein FPᵢₙ is the full price of each selected security (SSᵢₙ) and FIPᵢₙ is the full issuance price of each selected security (SSᵢₙ) and UCᵢ is the unallocated cash of the issuance based securities index and CYᵢ is interest rate earned on the unallocated cash (UCᵢ).

15. The system according to claim 14 further comprises an input device to input predefined parameters.

16. The system according to claim 14 further comprises an output device to display the set of instructions and results performed by the processor.

17. The system according to claim 14 wherein the issuance cycle (ICᵢₙ) is derived from the equation ICᵢₙ=kᵢ×max (IDᵢ₁, IDᵢ₂, IDᵢ₃ . . . IDᵢₙ), wherein kᵢ is a positive number.

18. The method of claim 14 wherein the issuance cycle (ICᵢ) is derived from the equation ICᵢ=kᵢ×min (IDᵢ₁, IDᵢ₂, IDᵢ₃ . . . IDᵢₙ), wherein kᵢ is a positive number.

19. The system of claim 14 wherein the notional weight (Wᵢₙ) is derived from the equation Wᵢₙ=Nᵢₙ/TNᵢ; wherein Nᵢₙ is the notional amount issued during RTᵢ for each selected security (SSᵢₙ), TNᵢ is the total notional amount issued during RTᵢ for each selected security (SSᵢₙ) and RTᵢ is defined as the reference time from (Tᵢ(pᵢ×ICᵢ)) until (Tᵢ) wherein pᵢ is a positive number and Tᵢ is the date of index reference.

20. The system of claim 14 wherein the expected allocation cycle (ACᵢₙ) is derived from equation: ACᵢₙ=APᵢ/IDᵢₙ; wherein APᵢ is defined as the allocation period from (TAᵢ) until (TAᵢ+(mᵢ×ICᵢ)) wherein mᵢ is a positive number and TAᵢ is the date of index allocation.

21. The system of claim 14 wherein the expected allocation cycle (ACᵢₙ) is derived from equation: ACᵢₙ=min (APᵢ/IDᵢₙ, 1); wherein APᵢ is defined as the allocation period from (TAᵢ) until (TAᵢ+(mᵢ×ICᵢ)) wherein mᵢ is a positive number and TAᵢ is the date of index allocation.

22. The system of claim 14 wherein the expected allocation cycle (ACᵢₙ) is derived from equation: ACᵢₙ=max (APᵢ/IDᵢₙ, 1); wherein APᵢ is defined as the allocation period from (TAᵢ) until (TAᵢ+(mᵢ×ICᵢ)) wherein mᵢ is a positive number and TAᵢ is the date of index allocation.

23. The system of claim 14 wherein the allocation weight (AWᵢₙ) is derived from equation AWᵢₙ=Wᵢₙ/ACᵢₙ.

24. The system of claim 14 wherein the allocation weight (AWᵢₙ) is derived from equation AWᵢₙ=Wᵢₙ/ACᵢₙ subject to ΣAWᵢₙ≦1.

25. The system of claim 14 wherein the index allocation (IAᵢₙ) is derived from equation IAᵢₙ=AWᵢₙ×AFᵢ.
